(19) United States
(12) Patent Application Publication
(10) Pub. No.: US 2021/0223865 A1
(43) Pub. Date: Jul. 22, 2021

(54) SIGNAL GENERATION FOR ACCURATE HAPTIC FEEDBACK

(71) Applicant: QUALCOMM Incorporated, San Diego, CA (US)

(72) Inventors: Van NGUYEN, San Diego, CA (US); Sang-Uk RYU, San Diego, CA (US); Shreyas Srikanth PAYAL, San Diego, CA (US); Hui-ya Liao NELSON, San Diego, CA (US)

(21) Appl. No.: 16/747,339

(22) Filed: Jan. 20, 2020

(51) Int. Cl. G06F 3/01; B06B 1/04

(52) U.S. Cl. CPC G06F 3/016; B06B 1/045; G06F 3/017

(57) ABSTRACT

Various aspects of the present disclosure generally relate to haptic feedback. In some aspects, a device may receive an input identifying a one-cycle induced acceleration waveform associated with a haptic device, a resonant frequency associated with the haptic device, and a target acceleration waveform for the haptic device. The device may determine a plurality of weights based at least in part on the input. The device may generate a playback waveform based at least in part on the plurality of weights. The device may provide the playback waveform as input to the haptic device. Numerous other aspects are provided.

### FIELD OF THE DISCLOSURE

Aspects of the present disclosure generally relate to haptic feedback and to signal generation for accurate haptic feedback.

### BACKGROUND

Haptic feedback may include various types of physical or mechanical outputs that produce tactile sensations for various purposes. Haptic feedback may be used to simulate the sensation of touching an object in a virtual environment, may be used to provide feedback or tactile indications in a control system, may be used to provide a physical or tactile element to music, among many other use cases.

### SUMMARY

In some aspects, a method performed by a device may include receiving an input identifying a one-cycle induced acceleration waveform associated with a haptic device, a resonant frequency associated with the haptic device, and a target acceleration waveform for the haptic device; determining a plurality of weights based at least in part on the input; generating a playback waveform based at least in part on the plurality of weights; and providing the playback waveform as input to the haptic device.

In some aspects, a device may include memory and one or more processors operatively coupled to the memory. The memory and the one or more processors may be configured to receive an input identifying a one-cycle induced acceleration waveform associated with a haptic device, a resonant frequency associated with the haptic device, and a target acceleration waveform for the haptic device; determine a plurality of weights based at least in part on the input; generate a playback waveform based at least in part on the plurality of weights; and provide the playback waveform as input to the haptic device.

In some aspects, a non-transitory computer-readable medium may store one or more instructions for wireless communication. The one or more instructions, when executed by one or more processors of a device, may cause the one or more processors to receive an input identifying a one-cycle induced acceleration waveform associated with a haptic device, a resonant frequency associated with the haptic device, and a target acceleration waveform for the haptic device; determine a plurality of weights based at least in part on the input; generate a playback waveform based at least in part on the plurality of weights; and provide the playback waveform as input to the haptic device.

In some aspects, an apparatus may include means for receiving an input identifying a one-cycle induced acceleration waveform associated with a haptic device, a resonant frequency associated with the haptic device, and a target acceleration waveform for the haptic device; means for determining a plurality of weights based at least in part on the input; means for generating a playback waveform based at least in part on the plurality of weights; and means for providing the playback waveform as input to the haptic device.

Aspects generally include a method, apparatus, system, computer program product, non-transitory computer-readable medium, user device, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram conceptually illustrating an example environment in which signal generation for accurate haptic feedback described herein may be implemented, in accordance with various aspects of the present disclosure.

FIG. 2 is a diagram conceptually illustrating example components of one or more devices shown in FIG. 1, such as a device or haptic device, in accordance with various aspects of the present disclosure.

FIGS. 3 and 4A-4P are diagrams conceptually illustrating examples associated with signal generation for accurate haptic feedback in accordance with various aspects of the present disclosure.

FIG. 5 is a flowchart of an example process associated with signal generation for accurate haptic feedback.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A haptic device may generate haptic feedback based at least in part on an input. The input may include a voltage waveform, an electrical current waveform, and/or the like. The haptic device may convert the input to a mechanical output as the haptic feedback, which may include a vibration, force feedback, or other types of haptic feedback. In some cases, the input voltage waveform or current waveform may be generated to match a desired playback waveform. For example, if the desired playback waveform is a uniform sinusoidal playback waveform having a constant peak acceleration throughout the playback waveform, the input to the haptic device may be a uniform voltage waveform (e.g., a sinusoidal voltage waveform wherein the voltage signal repeats at a particular period or frequency) to match the desired playback waveform. However, an input voltage waveform or current waveform that matches a desired playback waveform may not necessarily result in the haptic device producing the desired playback waveform. The properties and parameters of the haptic device may result in an actual output acceleration waveform from the haptic device which lags behind the desired playback waveform in reaching peak acceleration and/or which includes an undesirable ringing (e.g., vibration ringing) where the desired playback waveform stops. These effects may result in inaccurate haptic feedback, such as where haptic feedback does not match or synchronize with an associated audio signal, where haptic feedback does not match or synchronize with events occurring in a video game, and/or the like.

Some aspects described herein provide techniques and apparatuses for signal generation for accurate haptic feedback. In some aspects, a device may generate a playback waveform based at least in part on various types of inputs, such as a target acceleration waveform (e.g., which may correspond to a desired haptic feedback output from a haptic device), a one-cycle induced acceleration waveform of the haptic device, and a resonant frequency of the haptic device. The device may determine a plurality of weights based on the above-described inputs. The weights may be used to generate drive cycles of a playback waveform, which may increase or sustain acceleration in an output acceleration waveform of the haptic device (e.g., a waveform of the haptic feedback produced by the haptic device), and/or brake cycles of the playback waveform, which may decrease or stop acceleration in the output acceleration waveform of the haptic device. The device may generate a non-uniform playback waveform based at least in part on the weights. In this way, the techniques for generating haptic feedback described herein result in an accurate and crispier playback waveform (e.g., a playback waveform that quickly reaches peak acceleration and quickly stops) relative to generating haptic feedback using a uniform playback waveform.

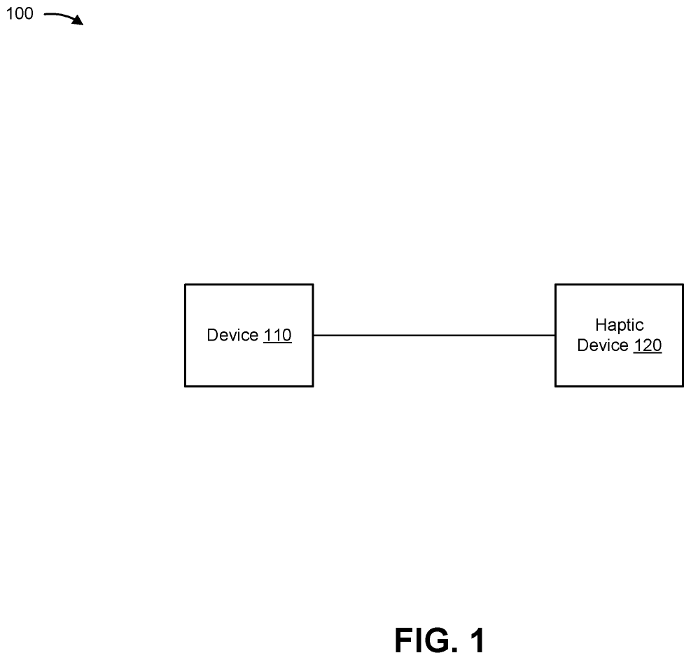

FIG. 1 is a diagram of an example environment 100 in which systems and/or methods described herein may be implemented. As shown in FIG. 1, environment 100 may include a device 110 and a haptic device 120. Devices of environment 100 may interconnect via wired connections, wireless connections, or a combination of wired and wireless connections. In some aspects, device 110 and haptic device 120 may be separate devices and may be communicatively connected via a wired or wireless connection. In some aspects, device 110 may include haptic device 120.

Device 110 includes one or more devices capable of generating a playback waveform for generating haptic feedback and providing the playback waveform to haptic device 120, as described herein. For example, device 110 may include a communication and/or computing device, such as a user equipment (e.g., a smartphone, a radiotelephone, and/or the like), a laptop computer, a tablet computer, a handheld computer, a wearable communication device (e.g., a smart wristwatch, a pair of smart eyeglasses, and/or the like), a gaming device (e.g., a video game console, a handheld game device, a wearable gaming device, a video game controller, and/or the like), a virtual reality device, an augmented reality device, or a similar type of device. As described herein, device 110 may be capable of receiving an input identifying a one-cycle induced acceleration waveform associated with haptic device 120, a resonant frequency associated with haptic device 120, and target acceleration waveform for haptic device 120; may be capable of determining a plurality of weights based at least in part on the input; may be capable of generating a playback waveform based at least in part on the plurality of weights; may be capable of providing the playback waveform as input to haptic device 120; and/or the like, as described herein.

Haptic device 120 includes one or more devices capable of receiving a playback waveform (e.g., from device 110) and converting the playback waveform into haptic feedback, a haptic response, or another type of haptic output. For example, haptic device 120 may include a linear resonance actuator, an eccentric rotating mass motor, a piezoelectric actuator, and/or another type of haptic device capable of receiving a playback waveform as input and generating a vibration output or pattern, force feedback, ultrasonic-induced pressure, or another type of haptic feedback or output based at least in part on the playback waveform.

The number and arrangement of devices and networks shown in FIG. 1 are provided as one or more examples. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

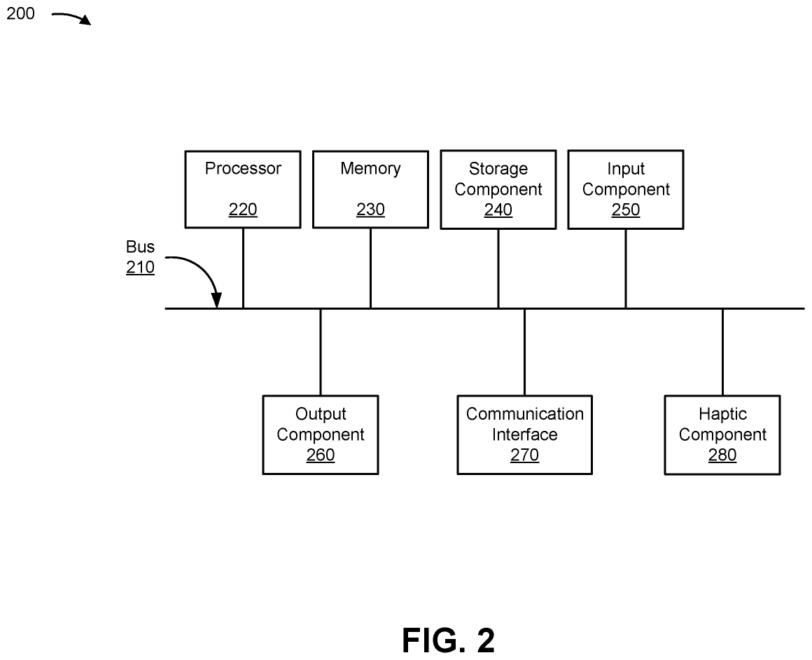

FIG. 2 is a diagram of example components of a device 200. Device 200 may correspond to device 110, haptic device 120, and/or the like. In some implementations, device 110, haptic device 120, and/or the like may include one or more devices 200 and/or one or more components of device 200. As shown in FIG. 2, in some aspects, such as where device 110 includes haptic device 120, device 200 may include a bus 210, a processor 220, a memory 230, a storage component 240, an input component 250, an output component 260, a communication interface 270, and a haptic component 280. In some aspects, such as where device 110 and haptic device 120 are separate devices, device 200 may include bus 210, processor 220, memory 230, storage component 240, input component 250, output component 260, and communication interface 270.

Bus 210 includes a component that permits communication among multiple components of device 200. Processor 220 is implemented in hardware, firmware, and/or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 250 includes a component that permits device 200 to receive information, such as via user input (e.g., a touch screen display, a keyboard, a keypad, a mouse, a button, a switch, and/or a microphone). Additionally, or alternatively, input component 250 may include a component for determining location (e.g., a global positioning system (GPS) component) and/or a sensor (e.g., an accelerometer, a gyroscope, an actuator, another type of positional or environmental sensor, and/or the like). Output component 260 includes a component that provides output information from device 200 (via, e.g., a display, a speaker, a haptic feedback component, an audio or visual indicator, and/or the like).

Communication interface 270 includes a transceiver-like component (e.g., a transceiver, a separate receiver, a separate transmitter, and/or the like) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, and/or the like.

Haptic component 280 includes one or more types of haptic devices or components that are capable of generating haptic feedback, or a haptic response, or another type of haptic output. For example, haptic component 280 may be capable of receiving a playback waveform as input and may be capable of generating haptic feedback based at least in part on the playback waveform, which may include a vibration output or pattern, force feedback, ultrasonic-induced pressure, or another type of haptic feedback or output. Examples of haptic devices or components include a linear resonance actuator, an eccentric rotating mass motor, a piezoelectric actuator, and/or the like.

In some aspects, device 200 includes means for performing one or more processes described herein and/or means for performing one or more operations of the processes described herein. For example, the means for performing the processes and/or operations described herein may include bus 210, processor 220, memory 230, storage component 240, input component 250, output component 260, communication interface 270, haptic component 280, and/or any combination thereof.

Device 200 may perform one or more processes described herein. Device 200 may perform these processes based on processor 220 executing software instructions stored by a non-transitory computer-readable medium, such as memory 230 and/or storage component 240. As used herein, the term “computer-readable medium” refers to a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

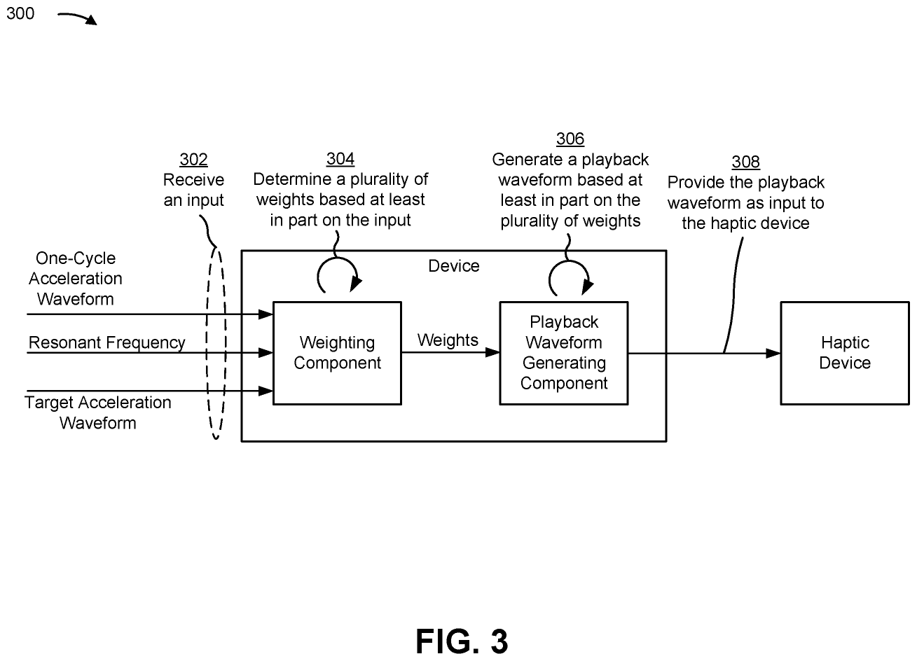

FIG. 3 is a diagram conceptually illustrating one or more examples 300 associated with signal generation for accurate haptic feedback in accordance with various aspects of the present disclosure. As shown in FIG. 3, example(s) 300 may include a device (e.g., device 110, device 200, and/or the like) and a haptic device (e.g., haptic device 120, device 200, and/or the like). In some aspects, the device 110 may include the haptic device 120. In some aspects, the device and the haptic device may be separate devices that are communicatively connected by a wired or wireless connection. In some aspects, the device may be capable of generating a playback waveform (e.g., a voltage waveform, a current waveform, and/or the like), which the haptic device may convert into a mechanical output to produce haptic feedback.

As shown in FIG. 3, and by reference number 302, to generate a playback waveform for the haptic device, the device may receive an input. In some aspects, the input may be received at a weighting component of the device (e.g., a weighting component implemented by one or more of the components illustrated in FIG. 2 above, such as a processor 220, a memory 230, and/or the like).

In some aspects, the input may include various types of information, such as information identifying a one-cycle induced acceleration waveform associated with the haptic device, information identifying a resonant frequency of the haptic device, information identifying a target waveform, and/or the like. The various types of information may be received from various sources and/or locations. For example, the weighting component may receive the information identifying the one-cycle induced acceleration waveform and the information identifying the resonant frequency from the haptic device or from a data store (e.g., a data store of the device, such as a memory, a database, a storage device, and/or the like, or from another location or device). As another example, the weighting component may receive the information identifying the target acceleration waveform from an application on the device or another device, from a video game being played on the device or another device, and/or the like.

In some aspects, the one-cycle induced acceleration waveform may include an acceleration waveform that is generated from a one-cycle input (e.g., one frequency cycle or one period of a test waveform) to the haptic device. In some aspects, the one-cycle induced acceleration waveform may be a measured one-cycle induced acceleration waveform. In this case, the one-cycle induced acceleration waveform may be generated by measuring the acceleration output of the haptic device resulting from a one-cycle waveform. This one-cycle waveform may be various shapes, amplitudes, or forms of one-cycle waveforms. As an example, the one-cycle waveform may be a one-cycle sinusoid. In other examples, the one-cycle waveform may be a clipped one-cycle sinusoid, a square wave shaped one-cycle waveform, a sawtooth wave shaped once-cycle waveform, and/or other waveforms. The acceleration output may be measured by attaching or mounting an accelerometer or another type of vibration sensing device and measuring the vibration produced by the haptic device using the accelerometer.

In some aspects, the one-cycle induced acceleration waveform may be simulated, estimated, or calculated based at least in part on a back electromotive force (BEMF) generated by the haptic device. The BEMF may be a voltage that is generated by the haptic device that is in series with and opposes the voltage of a playback waveform applied to the haptic device. The BEMF may be measured to infer or estimate the acceleration output of the haptic device. In some aspects, a BEMF-estimated one-cycle induced acceleration waveform may be nearly as accurate (and in some cases, more accurate) as a measured one-cycle induced acceleration waveform, while providing a more convenient and cost-effective means of obtaining a one-cycle induced acceleration waveform relative to fitting a haptic device with test equipment (e.g., an accelerometer) to measure the acceleration output of the haptic device.

In some aspects, the resonant frequency of the device may include an indication of a frequency at which the haptic device achieves resonance. The resonant frequency may be indicated in Hertz (e.g., 166 Hz, 177 Hz, and/or the like), megahertz, and/or another measurement of frequency.

In some aspects, the target acceleration waveform may identify the desired or target output acceleration waveform to be produced by the haptic device. In this case, the target acceleration waveform may indicate the desired or target haptic feedback to be produced by the haptic device. The target acceleration waveform may be associated with an effect or event in a video game, may be associated with information to be indicated in a control system or collision detection system (e.g., may indicate that a driver of a vehicle is in close proximity and/or is approaching an object), and/or the like. In some aspects, the target acceleration waveform may be a uniform acceleration waveform (e.g., where the peak acceleration of the waveform is constant throughout the waveform), may be a non-uniform acceleration waveform (e.g., a ramped acceleration waveform, an acceleration waveform where the acceleration changes throughout the acceleration waveform, and/or the like), and/or the like.

As further shown in FIG. 3, and by reference number 304, the device (e.g., the weighting component of the device) may determine a plurality of weights based at least in part on the various types of information included in the input. For example, the device may determine the plurality of weights based at least in part on the one-cycle induced acceleration waveform associated with the haptic device, the resonant frequency associated with the haptic device, the target acceleration waveform for the haptic device, and/or the like.

In some aspects, each of the plurality of weights may be used to weight a respective cycle of the playback waveform. A weight of the plurality of weights may be a positive weight or a negative weight. In some aspects, a positive weight may be used to cause a cycle of the playback waveform to increase, sustain, or maintain an acceleration in a corresponding cycle in an output acceleration waveform generated by the haptic device. This may be referred to a drive cycle of the playback waveform. In some aspects, a negative weight may be used to cause a cycle of the playback waveform to decrease or reduce an acceleration in a corresponding cycle in the output acceleration waveform generated by the haptic device. This may be referred to as a brake cycle. In other aspects, the techniques and apparatuses described herein may be applied in scenarios where the polarities of the different types of cycles are reversed such that negative weights are used for drive cycles and positive weights are used for brake cycles.

Drive cycles may be used to ramp the acceleration of the haptic device to a target acceleration of the target acceleration waveform, may be used to maintain the acceleration of the haptic device at or near a target acceleration of the target acceleration waveform, and/or the like. Brake cycles may be used to decrease the acceleration of the haptic device to a target to a target acceleration of the target acceleration waveform, may be used to stop acceleration of the haptic device (such as at the end of the playback waveform to reduce or prevent undesirable vibration ringing or acceleration ringing of the acceleration of the haptic device), and/or the like.

In some aspects, the device may determine the plurality of weights to accurately tailor the playback waveform for the haptic device such that the playback waveform causes the haptic device to generate haptic feedback having an output acceleration waveform that matches or closely resembles the target acceleration waveform. Accordingly, the device may determine any combination of positive weights and negative weights such that the plurality of weights includes one or more positive weights and/or one or more negative weights, depending on the target acceleration waveform to be matched. Moreover, the device may determine any combination of positive weights and negative weights for scenarios where drive cycles are positive weighted and brake cycles are negative weighted, as well as for scenarios where drive cycles are negative weighted and brake cycles are positive weighted.

In some aspects, the device may determine the plurality of weights such that the playback waveform is sequentially weighted. In this case, the device may determine the plurality of weights such that a time delay or time offset is applied to each weight so that the weights are staggered in the time domain. This causes each of the plurality of weights to be applied to a respective cycle of the playback waveform in a sequential manner. As an example, the device may determine a first weight for a first cycle of the playback waveform, may determine a second weight that is time delayed relative to the first weight such that the second weight is applied to the next cycle (second cycle) in the playback waveform, may determine a third weight that is time delayed relative to the second weight such that the third weight is applied to the next cycle (third cycle) in the playback waveform, and so on.

In some aspects, once the device has determined the plurality of weights, the device may determine whether the plurality of weights is expected to result in a crest factor (e.g., a peak voltage to root means square (RMS) voltage ratio) that satisfies a threshold. The device may determine whether the plurality of weights is expected to result in a crest factor that satisfies the threshold to prevent voltage clipping for the haptic device (e.g., to prevent the voltage of the playback waveform from exceeding a voltage capability of the haptic device, which may cause distortion in the haptic feedback generated by the haptic device and/or which may cause damage to the haptic device). Scenarios where the plurality of weights may cause a crest factor to not satisfy the threshold may include a relatively quick acceleration increase to a desired or specified acceleration, a relatively quick acceleration decrease to a desired or specified acceleration, and/or the like. These scenarios may result in relatively high voltages to quickly accelerate or deaccelerate the haptic device.

To reduce or prevent voltage clipping and/or damage to the haptic device, the device may perform one or more actions based at least in part on determining that the plurality of weights may cause a crest factor to not satisfy the threshold. For example, the device may increase the quantity of weights to increase the quantity of cycles in the resulting playback waveform, may decrease the ramp in acceleration or deceleration that is to be produced by the playback waveform (e.g., which may be achieved by adjusting one or more of the plurality of weights to more slowly ramping up or ramping down the voltage in the playback waveform), and/or the like.

As further shown in FIG. 3, and by reference number 306, the device may generate the playback waveform based at least in part on the plurality of weights. In this case, the weighting component may provide the plurality of weights to a playback waveform generating component (e.g., which may be implemented by a processor 220, a memory 230, and/or the like of the device), and the waveform generating component may generate the playback waveform based at least in part on the plurality of weights. To generate the playback waveform, the device may generate a plurality of cycles (e.g., drive cycles, brake cycles, and/or the like) corresponding to the plurality of weights. In this case, the voltage of each cycle of the playback waveform may be based at least in part on the weight associated with each cycle. In some aspects, the voltage for a cycle of the playback waveform may be based at least in part on a magnitude of the weight for the cycle, may be based at least in part on whether the weight is a positive weight or a negative weight, may be based on the time delay or time offset for the weight, and/or the like.

As further shown in FIG. 3, and by reference number 308, the device (e.g., the playback waveform generating component of the device) may provide the playback waveform as input to the haptic device. The playback waveform may cause the haptic device to produce haptic feedback having an output waveform similar to or closely matching the target acceleration waveform received as input at the weighting component of the device. For example, the haptic device may convert the electrical (e.g., voltage or current) input of the playback waveform to a mechanical motion or mechanical output, such as a vibration, a force feedback, and/or the like as the haptic feedback.

In this way, the device may generate a playback waveform based at least in part on various types of inputs, such as a target acceleration waveform (e.g., which may correspond to a desired haptic feedback output from the haptic device), a one-cycle induced acceleration waveform of the haptic device, and a resonant frequency of the haptic device. The device may determine a plurality of weights based on the above-described inputs. The weights may be used to generate drive cycles and/or brake cycles of the playback waveform. The device may generate a non-uniform playback waveform based at least in part on the weights. In this way, the techniques for generating haptic feedback described herein result in an accurate and crispier playback waveform (e.g., a playback waveform that quickly reaches peak acceleration and quickly stops) relative to generating haptic feedback using a uniform playback waveform.

As indicated above, FIG. 3 is provided as one or more examples. Other examples may differ from what is described with regard to FIG. 3.

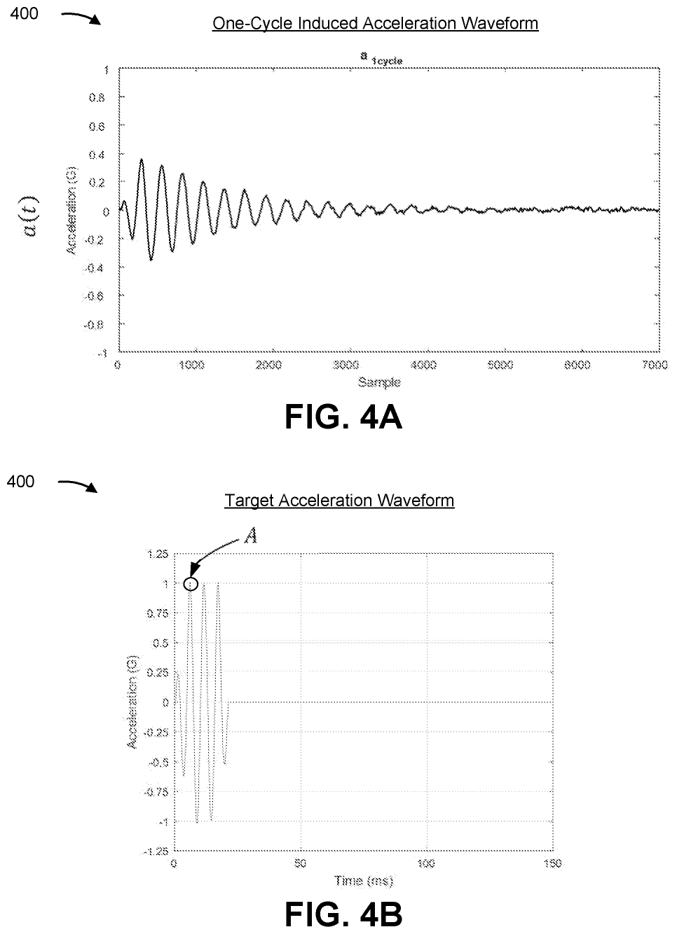

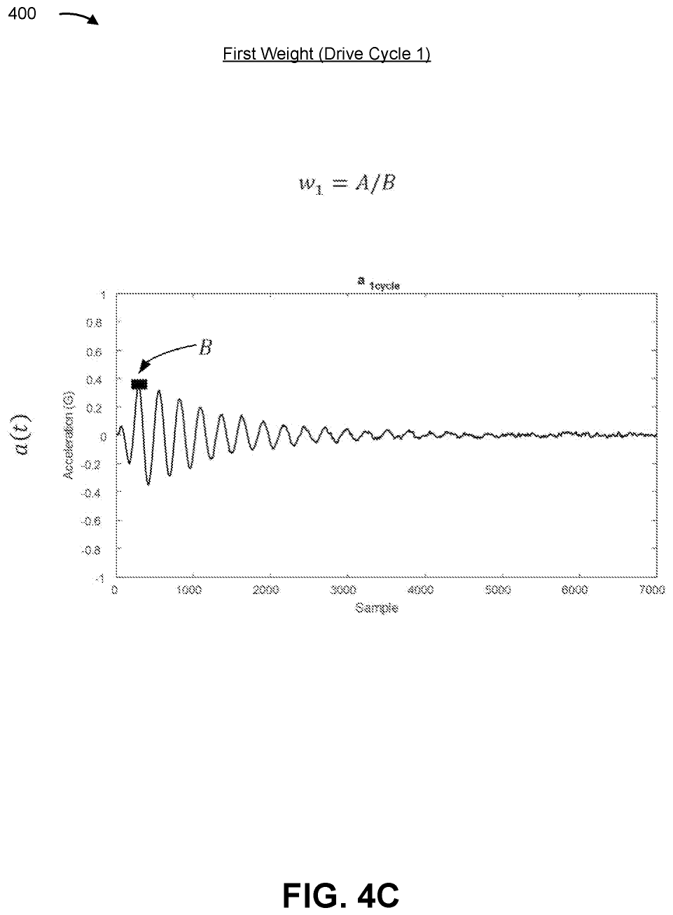

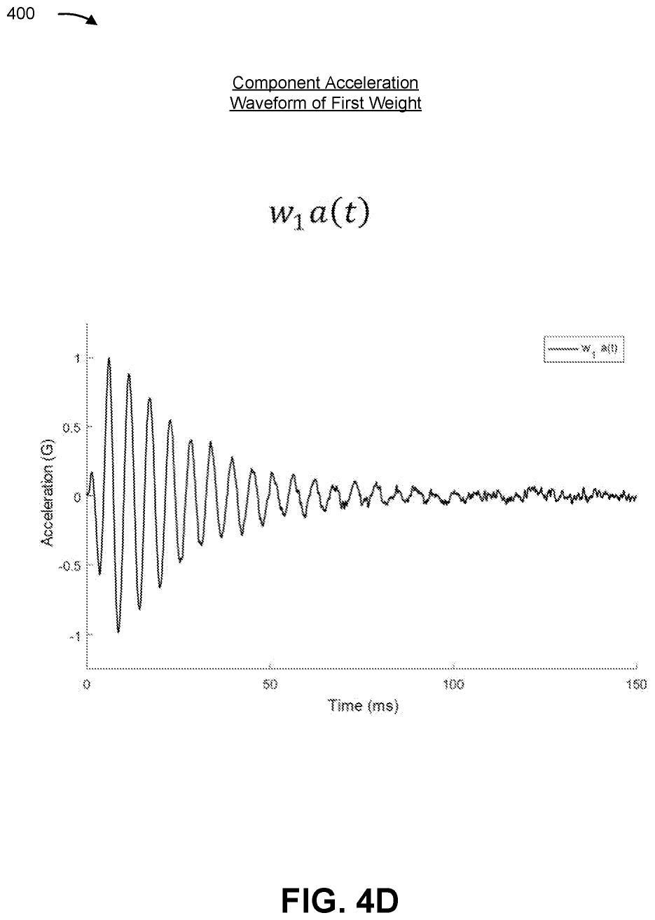

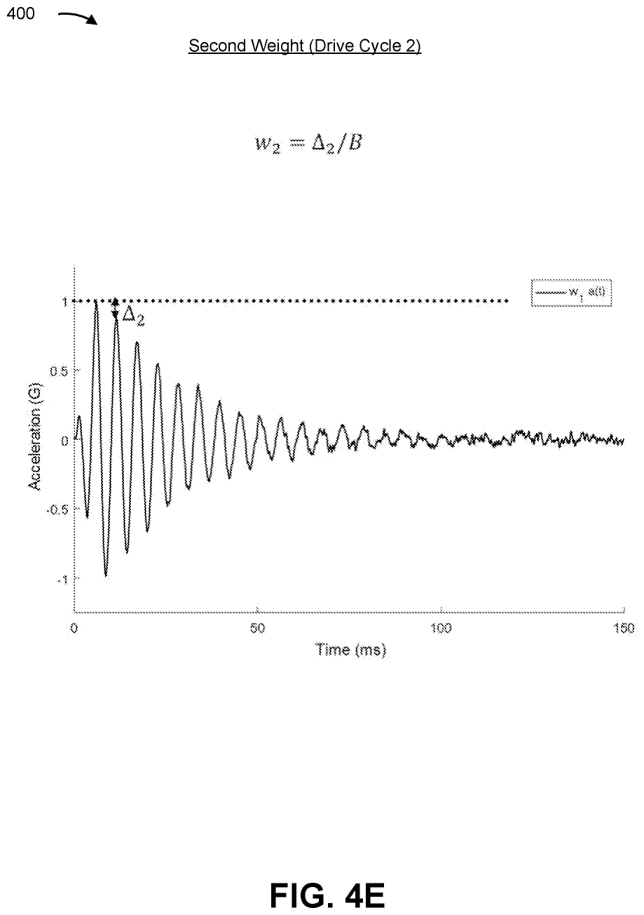

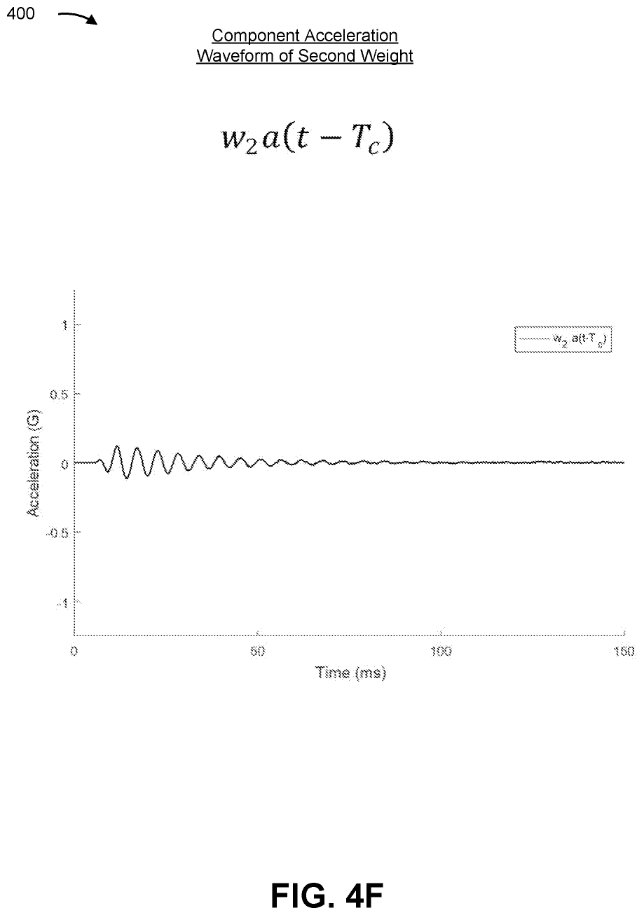

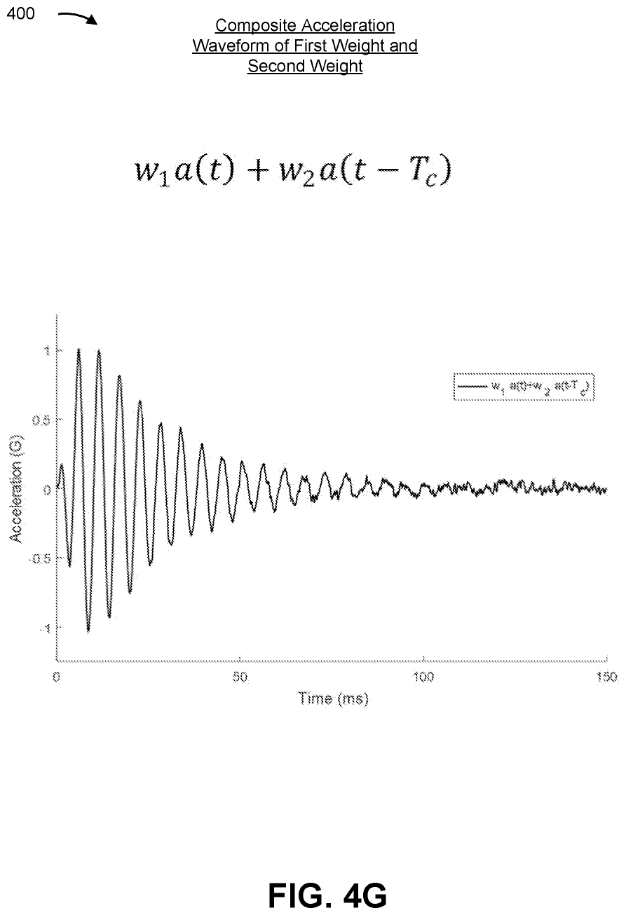

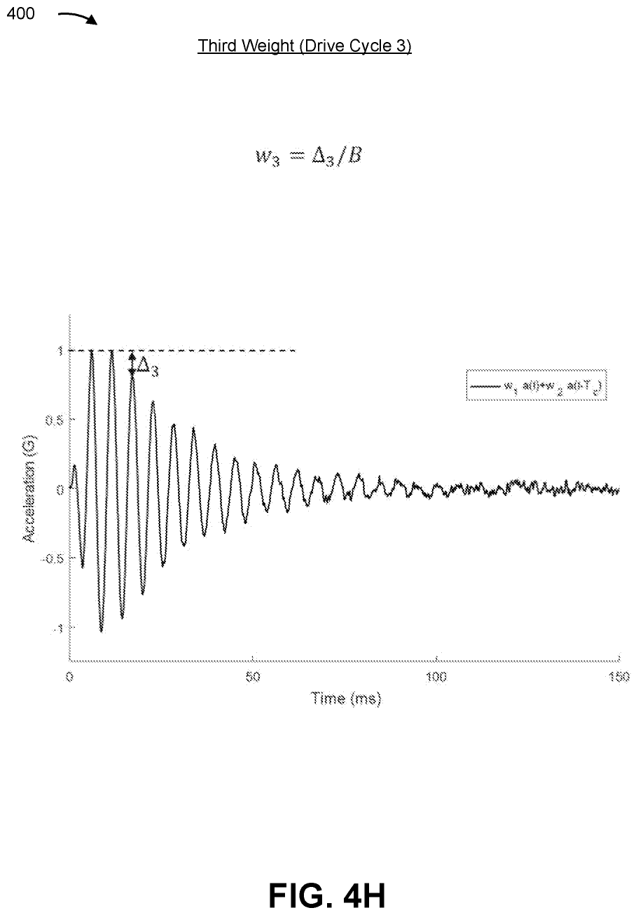

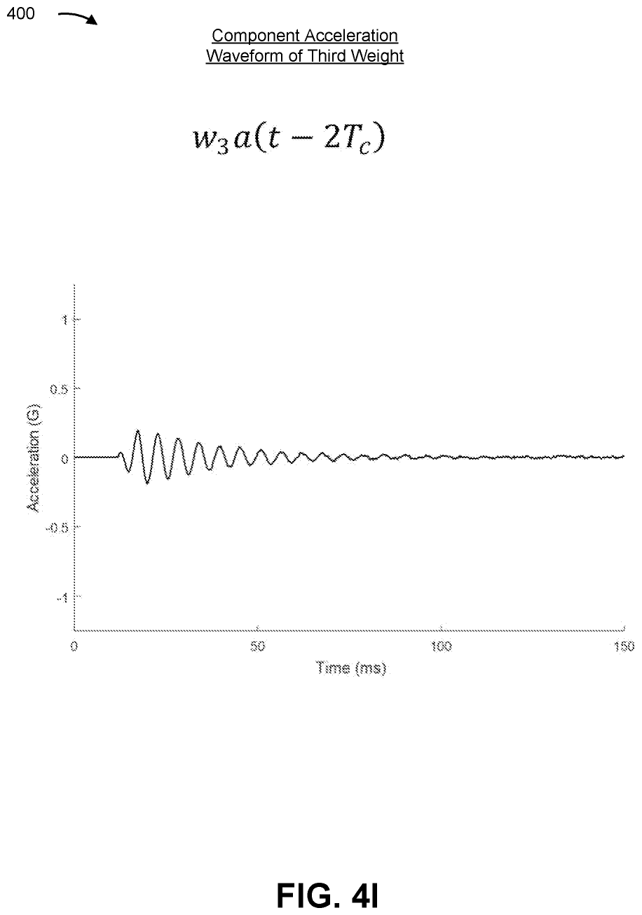

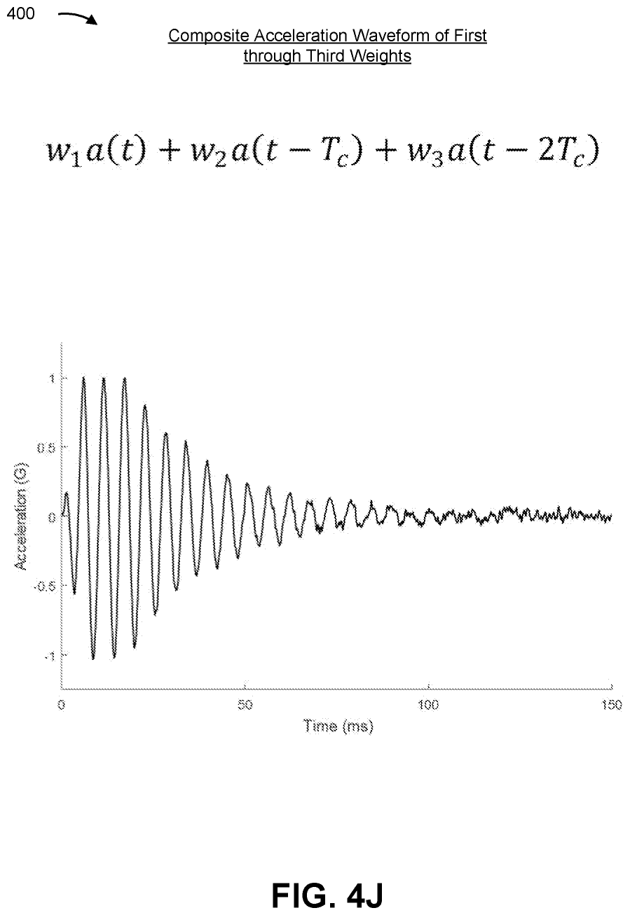

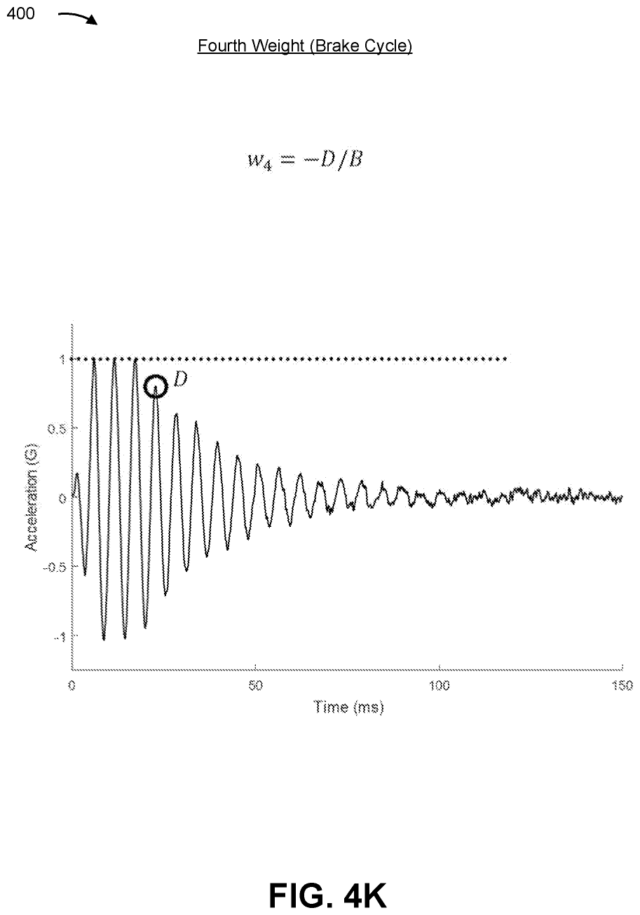

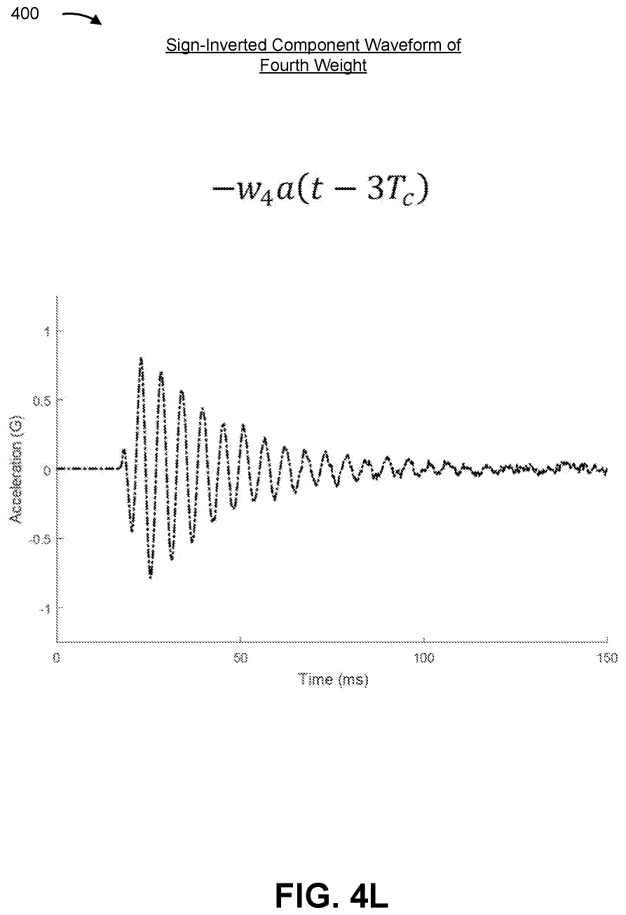

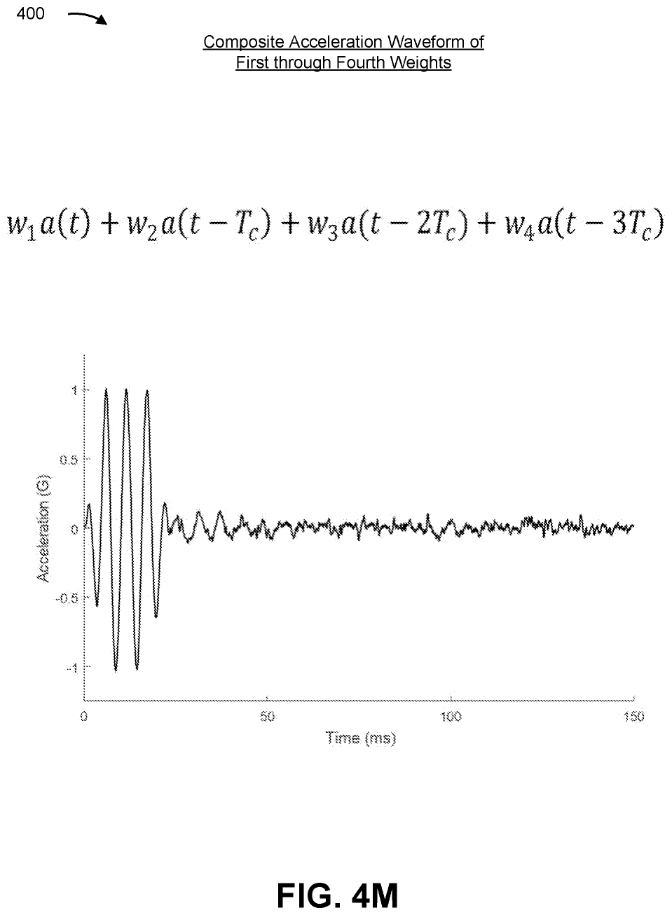

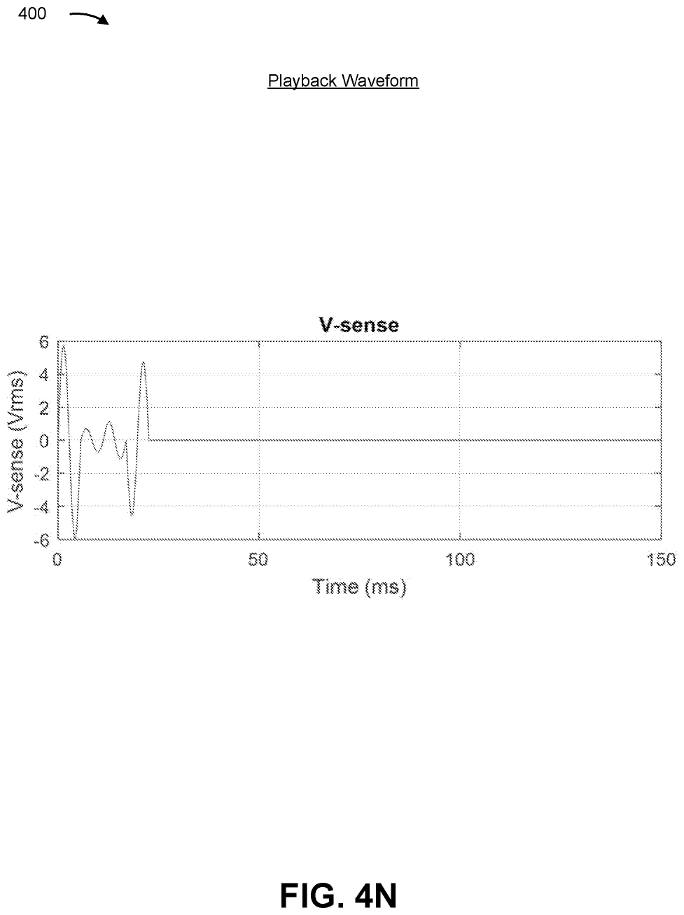

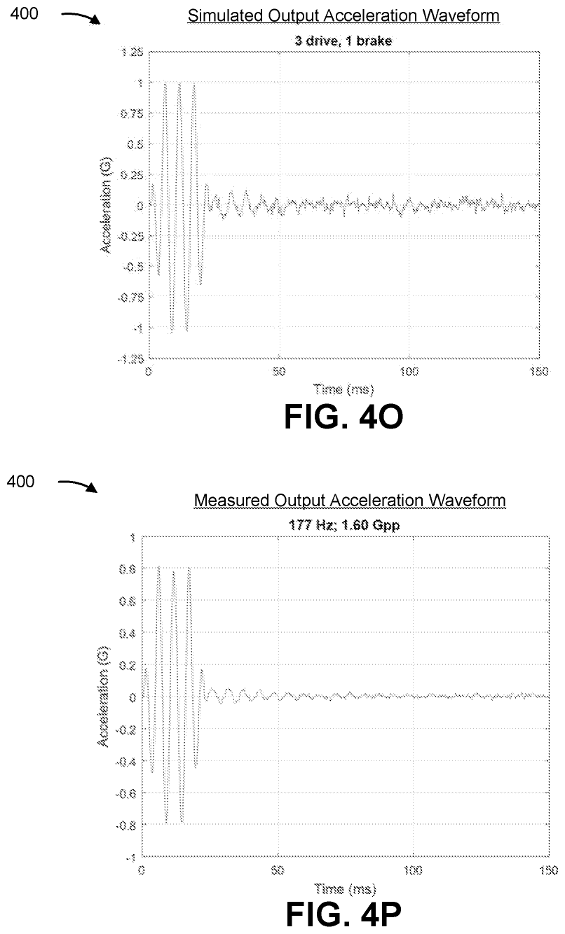

FIGS. 4A-4P are diagrams conceptually illustrating one or more examples 400 associated with signal generation for accurate haptic feedback in accordance with various aspects of the present disclosure. Example(s) 400 may illustrate an example of generating a playback waveform by a device (e.g., device 110, device 200, the device illustrated and described in FIG. 3, and/or the like). In some aspects, example(s) 400 illustrated in FIGS. 4A-4P illustrate the generation of a playback waveform having four cycles (e.g., three drive cycles and one brake cycle). However, the playback waveform generated in example(s) 400 is an example playback waveform only, and other playback waveforms having a greater or fewer quantity of drive cycles and/or a greater or fewer quantity of brake cycles may be generated based at least in part on the techniques described herein.

FIG. 4A illustrates an example one-cycle induced acceleration waveform of a haptic device (e.g., haptic device 120, device 200, the haptic device illustrated and described in FIG. 3, and/or the like) for which the device may generate the playback waveform. FIG. 4B illustrates an example target acceleration waveform for the haptic device. As illustrated in FIG. 4B, the target acceleration waveform may include three cycles that have a uniform or constant peak acceleration of A (e.g., 1G or another example peak acceleration). In some aspects, the device may generate the playback waveform based at least in part on the one-cycle induced acceleration waveform illustrated in FIG. 4A, the target acceleration waveform illustrated in FIG. 4B, and the resonant frequency of the haptic device such that the playback waveform causes the haptic device to produce haptic feedback having an output waveform that is similar to and/or closely matches the target acceleration waveform illustrated in FIG. 4B.

As shown in FIG. 4C, the device may determine a first weight w₁ for a first cycle of the playback waveform (e.g., drive cycle 1). The device may determine the first weight as:

w₁=A/B

where B corresponds to the value of the highest or greatest peak acceleration of the one-cycle induced acceleration waveform.

As shown in FIG. 4D, the device may determine or compute the estimated result of the first weight applied to the one-cycle induced acceleration waveform. The result may be a first component acceleration waveform associated with the first weight. The first component acceleration waveform may be denoted as w₁α(t), where t is the first time offset applied to the first weight.

As shown in FIG. 4E, the device may determine the second weight w₂ for the second cycle of the playback waveform (e.g., drive cycle 2) based at least in part on a difference in acceleration Δ₂ between the peak acceleration of the second cycle in the first component acceleration waveform and the peak acceleration of the second cycle in the target acceleration waveform (e.g., 1G). In this case, the device may determine the second weight as:

w₂=Δ₂/B

A shown in FIG. 4F, the device may determine a second component acceleration waveform resulting from the second weight. The second component waveform may be denoted as w₂α(t−T_{c}), where T_{c}. is the inverse of the resonance frequency of the haptic device and t−T_{c} is the second time offset applied to the second weight.

As shown in FIG. 4G, the device may determine a composite acceleration waveform resulting from a combination of the first weight and the second weight. The composite acceleration waveform resulting from a combination of the first weight and the second weight may be described as w₁α(t)+w₂a(t−Tₐ).

As shown in FIG. 4H, the device may determine a third weight w₃ for the third cycle of the playback waveform (e.g., drive cycle 3) based at least in part on a difference in acceleration Δ₃ between the peak acceleration of the third cycle in the composite acceleration waveform for the first weight and the second weight, and the peak acceleration of the third cycle in the target acceleration waveform (e.g., 1G). In this case, the device may determine the second weight as:

w₃=Δ₃/B

A shown in FIG. 41, the device may determine a third component acceleration waveform resulting from the third weight. The third component waveform may be denoted as w₃α(t−2T_{c}), where t−2T_{c} is the third time offset applied to the second weight.

As shown in FIG. 4J, the device may determine a composite acceleration waveform resulting from a combination of the first weight, the second weight, and the third weight. The composite acceleration waveform resulting from a combination of the first weight, the second weight, and the third weight may be described as w₁α(t)+w₂α(t−T_{c})+w₃α(t−2T_{c}).

As shown in FIG. 4K, the device may determine a fourth weight w₄ for the fourth cycle of the playback waveform. In this case, the fourth cycle of the playback waveform may be a brake cycle designed to bring the acceleration of the haptic device down to zero or near-zero to correspond with the ending of the target acceleration waveform. The device may determine the fourth weight based at least in part on the acceleration D of the peak acceleration of the fourth cycle in the composite acceleration waveform for the first weight the second weight, and the third weight. In this case, the device may determine the second weight as:

w₄=−D/B

Thus, the fourth weight may be determined to negate or counteract the acceleration D of the peak acceleration of the fourth cycle in the composite acceleration waveform for the first weight the second weight, and the third weight, such that the fourth weight causes the acceleration of the haptic device down to zero or near-zero after the third cycle. Moreover, the phase of the fourth weight is a 180° -shifted weight or a reversed-polarity weight, and thus reduces the acceleration of the haptic device down to zero or near-zero after the third cycle.

A shown in FIG. 4L, the device may determine a fourth component acceleration waveform resulting from the fourth weight. The fourth component waveform may be denoted as −w₄α(t−3T_{c}), where t−3T_{c} is the fourth time offset applied to the fourth weight.

As shown in FIG. 4M, the device may determine a composite acceleration waveform resulting from a combination of the first weight, the second weight, the third weight, and the fourth weight. The composite acceleration waveform resulting from a combination of the first weight, the second weight, the third weight, and the fourth weight may be described as w₁α(t)+w₂α(t−T_{c})+w₃α(t−2T_{c})+w₄α(t−3T_{c}).

As shown in FIG. 4N, the device may generate the playback waveform based at least in part on weights w₁ through w₄. The resulting waveform may be a non-uniform voltage waveform (e.g., a voltage waveform where the peak voltage of at least a subset of the cycles of the voltage waveform are different). The device may provide the playback waveform as input to the haptic device to cause the haptic device to generate haptic feedback based at least in part on the playback waveform.

In some aspects, the device may generate the playback waveform by applying the weights w₁ through w₄ to a one-cycle waveform. This one-cycle waveform may be various shapes, amplitudes, or forms of one-cycle waveforms. As an example, the one-cycle waveform may be a one-cycle sinusoid, as the example playback waveform illustrated in FIG. 4N. In other examples, the one-cycle waveform may be a clipped one-cycle sinusoid, a square wave shaped one-cycle waveform, a sawtooth wave shaped once-cycle waveform, and/or other waveforms.

FIGS. 40 and 4P respectively illustrate an example simulated output acceleration waveform for the haptic device and an example measured output acceleration waveform of the haptic device. The haptic device may have a resonant frequency of 177 Hz for the examples illustrated in FIGS. 40 and 4P. As shown in FIGS. 40 and 4P, the simulated (or calculated) output acceleration waveform and the measured output waveform may produce similar results, and both the simulated (or calculated) output acceleration waveform and the measured output waveform are similar and/or closely match the target acceleration waveform illustrated in FIG. 4B.

As indicated above, FIGS. 4A-4P are provided as one or more examples. Other examples may differ from what is described with regard to FIGS. 4A-4P. For example, while the example drive cycles illustrated in connection with FIGS. 4A-4P are described as having positive weights and the example brake cycle illustrated in connection with FIGS. 4A-4P are described as having a negative weight, the techniques described herein may be applied in scenarios where the sign or polarity of the weights are reversed such that the drive cycles have negative weights and the brake cycle(s) have positive weights. In some examples, the sign, polarity, or phase of the weights applied to the drive cycles and brake cycles may be based at least in part on the phase of the one-cycle waveform that is used to generate the playback waveform.

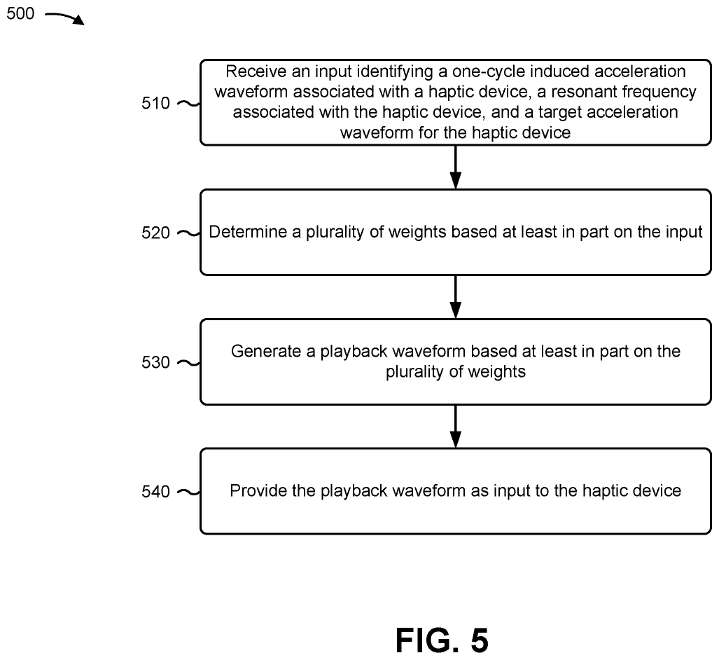

FIG. 5 is a diagram illustrating an example process 500 performed, for example, by a device, in accordance with various aspects of the present disclosure. Example process 500 is an example where the device (e.g., device 110, haptic device 120, device 200, and/or the like) performs operations associated with signal generation for accurate haptic feedback.

As shown in FIG. 5, in some aspects, process 500 may include receiving an input identifying a one-cycle induced acceleration waveform associated with a haptic device, a resonant frequency associated with the haptic device, and a target acceleration waveform for the haptic device (block 510). For example, the device (e.g., using processor 220, memory 230, storage component 240, input component 250, output component 260, communication interface 270, haptic component 280, and/or the like) may receive an input identifying a one-cycle induced acceleration waveform associated with a haptic device, a resonant frequency associated with the haptic device, and a target acceleration waveform for the haptic device, as described above.

As further shown in FIG. 5, in some aspects, process 500 may include determining a plurality of weights based at least in part on the input (block 520). For example, the device (e.g., using processor 220, memory 230, storage component 240, input component 250, output component 260, communication interface 270, haptic component 280, and/or the like) may determine a plurality of weights based at least in part on the input, as described above.

As further shown in FIG. 5, in some aspects, process 500 may include generating a playback waveform based at least in part on the plurality of weights (block 530). For example, the device (e.g., using processor 220, memory 230, storage component 240, input component 250, output component 260, communication interface 270, haptic component 280, and/or the like) may generate a playback waveform based at least in part on the plurality of weights, as described above.

As further shown in FIG. 5, in some aspects, process 500 may include providing the playback waveform as input to the haptic device (block 540). For example, the device (e.g., using processor 220, memory 230, storage component 240, input component 250, output component 260, communication interface 270, haptic component 280, and/or the like) may provide the playback waveform as input to the haptic device, as described above.

Process 500 may include additional aspects, such as any single aspect or any combination of aspects described below and/or in connection with one or more other processes described elsewhere herein.

In a first aspect, the one-cycle induced acceleration waveform is a measured one-cycle induced acceleration waveform. In a second aspect, alone or in combination with the first aspect, the one-cycle induced acceleration waveform is estimated based at least in part on a back electromotive force generated by the haptic device. In a third aspect, alone or in combination with one or more of the first and second aspects, the plurality of weights comprise one or more positive weights corresponding to one or more drive cycles of the playback waveform and one or more negative weights corresponding to one or more brake cycles of the playback waveform.

In a fourth aspect, alone or in combination with one or more of the first through third aspects, a subset of the one or more brake cycles is to reduce vibration ringing of the haptic device. In a fifth aspect, alone or in combination with one or more of the first through fourth aspects, determining the plurality of weights comprises determining a first weight of the plurality of weights, determining a second weight of the plurality of weights based at least in part on a first component acceleration waveform resulting from the first weight being applied to the one-cycle induced cceleration waveform, and determining a third weight of the plurality of weights based at least in part on a composite acceleration waveform resulting from a combination of the first component acceleration waveform and a second component acceleration waveform resulting from the second weight being applied to the one-cycle induced acceleration waveform.

In a sixth aspect, alone or in combination with one or more of the first through fifth aspects, determining the first weight comprises determining the first weight based at least in part on a difference in acceleration between a first cycle of the one-cycle induced acceleration waveform and a first cycle of the target acceleration waveform, determining the second weight comprises determining the second weight based at least in part on a difference in acceleration between a second cycle of the first component acceleration waveform and a second cycle of the target acceleration waveform, and determining the third weight comprises determining the third weight based at least in part on a difference in acceleration between a third cycle of the composite acceleration waveform and a third cycle of the target acceleration waveform.

In a seventh aspect, alone or in combination with one or more of the first through sixth aspects, process 500 includes determining that the plurality of weights is expected to result in a crest factor that satisfies a threshold and at least one of adjusting a subset of the plurality of weights based at least in part on determining that the plurality of weights is expected to result in the crest factor that satisfies the threshold or increasing a quantity of the plurality of weights based at least in part on determining that the plurality of weights is expected to result in the crest factor that satisfies the threshold.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a device, comprising:
receiving an input identifying:
a one-cycle induced acceleration waveform associated with a haptic device,
a resonant frequency associated with the haptic device, and
a target acceleration waveform for the haptic device;
determining a plurality of weights based at least in part on the input;
generating a playback waveform based at least in part on the plurality of weights; and
providing the playback waveform as input to the haptic device.

2. The method of claim 1, wherein the one-cycle induced acceleration waveform is a measured one-cycle induced acceleration waveform.

3. The method of claim 1, wherein the one-cycle induced acceleration waveform is estimated based at least in part on a back electromotive force generated by the haptic device.

4. The method of claim 1, wherein the plurality of weights comprise:
one or more positive weights corresponding to one or more drive cycles of the playback waveform; and
one or more negative weights corresponding to one or more brake cycles of the playback waveform.

5. The method of claim 4, wherein a subset of the one or more brake cycles is to reduce vibration ringing of the haptic device.

6. The method of claim 1, wherein determining the plurality of weights comprises:
determining a first weight of the plurality of weights;
determining a second weight of the plurality of weights based at least in part on a first component acceleration waveform resulting from the first weight being applied to the one-cycle induced acceleration waveform; and
determining a third weight of the plurality of weights based at least in part on a composite acceleration waveform resulting from a combination of the first component acceleration waveform and a second component acceleration waveform resulting from the second weight being applied to the one-cycle induced acceleration waveform.

7. The method of claim 6, wherein determining the first weight comprises:
determining the first weight based at least in part on a difference in acceleration between a first cycle of the one-cycle induced acceleration waveform and a first cycle of the target acceleration waveform;
wherein determining the second weight comprises:
determining the second weight based at least in part on a difference in acceleration between a second cycle of the first component acceleration waveform and a second cycle of the target acceleration waveform; and
wherein determining the third weight comprises:
determining the third weight based at least in part on a difference in acceleration between a third cycle of the composite acceleration waveform and a third cycle of the target acceleration waveform.

8. The method of claim 1, further comprising:
determining that the plurality of weights is expected to result in a crest factor that satisfies a threshold; and
at least one of:
adjusting a subset of the plurality of weights based at least in part on determining that the plurality of weights is expected to result in the crest factor that satisfies the threshold, or
increasing a quantity of the plurality of weights based at least in part on determining that the plurality of weights is expected to result in the crest factor that satisfies the threshold.

9. A device, comprising:
a memory; and
one or more processors operatively coupled to the memory, the memory and the one or more processors configured to:
receive an input identifying:
a one-cycle induced acceleration waveform associated with a haptic device,
a resonant frequency associated with the haptic device, and
a target acceleration waveform for the haptic device;
determine a plurality of weights based at least in part on the input;
generate a playback waveform based at least in part on the plurality of weights; and
provide the playback waveform as input to the haptic device.

10. The device of claim 9, wherein the one-cycle induced acceleration waveform is a measured one-cycle induced acceleration waveform.

11. The device of claim 9, wherein the one-cycle induced acceleration waveform is estimated based at least in part on a back electromotive force generated by the haptic device.

12. The device of claim 9, wherein the plurality of weights comprise:
one or more positive weights corresponding to one or more drive cycles of the playback waveform; and
one or more negative weights corresponding to one or more brake cycles of the playback waveform.

13. The device of claim 12, wherein a subset of the one or more brake cycles is to reduce vibration ringing of the haptic device.

14. The device of claim 9, wherein the one or more processors, when determining the plurality of weights, are configured to:
determine a first weight of the plurality of weights;
determine a second weight of the plurality of weights based at least in part on a first component acceleration waveform resulting from the first weight being applied to the one-cycle induced acceleration waveform; and
determine a third weight of the plurality of weights based at least in part on a composite acceleration waveform resulting from a combination of the first component acceleration waveform and a second component acceleration waveform resulting from the second weight being applied to the one-cycle induced acceleration waveform.

15. The device of claim 14, wherein the one or more processors, when determining the first weight, are configured to:
determine the first weight based at least in part on a difference in acceleration between a first cycle of the one-cycle induced acceleration waveform and a first cycle of the target acceleration waveform;
wherein determining the second weight comprises:
determine the second weight based at least in part on a difference in acceleration between a second cycle of the first component acceleration waveform and a second cycle of the target acceleration waveform; and
wherein determining the third weight comprises:
determine the third weight based at least in part on a difference in acceleration between a third cycle of the composite acceleration waveform and a third cycle of the target acceleration waveform.

16. The device of claim 9, wherein the one or more processors are further configured to:
determine that the plurality of weights is expected to result in a crest factor that satisfies a threshold; and
at least one of:
adjust a subset of the plurality of weights based at least in part on determining that the plurality of weights is expected to result in the crest factor that satisfies the threshold, or
increase a quantity of the plurality of weights based at least in part on determining that the plurality of weights is expected to result in the crest factor that satisfies the threshold.

17. A non-transitory computer-readable medium storing one or more instructions for wireless communication, the one or more instructions comprising:
one or more instructions that, when executed by one or more processors of a device, cause the one or more processors to:
receive an input identifying:
a one-cycle induced acceleration waveform associated with a haptic device,
a resonant frequency associated with the haptic device, and
a target acceleration waveform for the haptic device;
determine a plurality of weights based at least in part on the input;
generate a playback waveform based at least in part on the plurality of weights; and
provide the playback waveform as input to the haptic device.

18. The non-transitory computer-readable medium of claim 17, wherein the one-cycle induced acceleration waveform is:
a measured one-cycle induced acceleration waveform, or estimated based at least in part on a back electromotive force generated by the haptic device.

19. The non-transitory computer-readable medium of claim 17, wherein the plurality of weights comprise:
one or more positive weights corresponding to one or more drive cycles of the playback waveform; and
one or more negative weights corresponding to one or more brake cycles of the playback waveform.

20. The non-transitory computer-readable medium of claim 19, wherein a subset of the one or more brake cycles is to reduce vibration ringing of the haptic device.

21. The non-transitory computer-readable medium of claim 17, wherein the one or more instructions, that cause the one or more processors to determine the plurality of weights, cause the one or more processors to:
determine a first weight of the plurality of weights;
determine a second weight of the plurality of weights based at least in part on a first component acceleration waveform resulting from the first weight being applied to the one-cycle induced acceleration waveform; and
determine a third weight of the plurality of weights based at least in part on a composite acceleration waveform resulting from a combination of the first component acceleration waveform and a second component acceleration waveform resulting from the second weight being applied to the one-cycle induced acceleration waveform.

22. The non-transitory computer-readable medium of claim 21, wherein the one or more instructions, that cause the one or more processors to determine the first weight, cause the one or more processors to:
determine the first weight based at least in part on a difference in acceleration between a first cycle of the one-cycle induced acceleration waveform and a first cycle of the target acceleration waveform;
wherein determining the second weight comprises:
determine the second weight based at least in part on a difference in acceleration between a second cycle of the first component acceleration waveform and a second cycle of the target acceleration waveform; and
wherein determining the third weight comprises:
determine the third weight based at least in part on a difference in acceleration
between a third cycle of the composite acceleration waveform and a third cycle of the target acceleration waveform.

23. The non-transitory computer-readable medium of claim 17, wherein the one or more instructions, when executed by the one or more processors, further cause the one or more processors to:
determine that the plurality of weights is expected to result in a crest factor that satisfies a threshold; and
at least one of:
adjust a subset of the plurality of weights based at least in part on determining that the plurality of weights is expected to result in the crest factor that satisfies the threshold, or
increase a quantity of the plurality of weights based at least in part on determining that the plurality of weights is expected to result in the crest factor that satisfies the threshold.

24. An apparatus, comprising:
means for receiving an input identifying:
a one-cycle induced acceleration waveform associated with a haptic device,
a resonant frequency associated with the haptic device, and
a target acceleration waveform for the haptic device;
means for determining a plurality of weights based at least in part on the input;
means for generating a playback waveform based at least in part on the plurality of weights; and
means for providing the playback waveform as input to the haptic device.

25. The apparatus of claim 24, wherein the one-cycle induced acceleration waveform is:
a measured one-cycle induced acceleration waveform, or
estimated based at least in part on a back electromotive force generated by the haptic device.

26. The apparatus of claim 24, wherein the plurality of weights comprise:
one or more positive weights corresponding to one or more drive cycles of the playback waveform; and
one or more negative weights corresponding to one or more brake cycles of the playback waveform.

27. The apparatus of claim 26, wherein a subset of the one or more brake cycles is to reduce vibration ringing of the haptic device.

28. The apparatus of claim 24, wherein determining the plurality of weights comprises:
means for determining a first weight of the plurality of weights;
means for determining a second weight of the plurality of weights based at least in part on a first component acceleration waveform resulting from the first weight being applied to the one-cycle induced acceleration waveform; and
means for determining a third weight of the plurality of weights based at least in part on a composite acceleration waveform resulting from a combination of the first component acceleration waveform and a second component acceleration waveform resulting from the second weight being applied to the one-cycle induced acceleration waveform.

29. The apparatus of claim 28, wherein determining the first weight comprises:
means for determining the first weight based at least in part on a difference in acceleration between a first cycle of the one-cycle induced acceleration waveform and a first cycle of the target acceleration waveform;
wherein determining the second weight comprises:
means for determining the second weight based at least in part on a difference in acceleration between a second cycle of the first component acceleration waveform and a second cycle of the target acceleration waveform; and
wherein determining the third weight comprises:
means for determining the third weight based at least in part on a difference in acceleration between a third cycle of the composite acceleration waveform and a third cycle of the target acceleration waveform.

30. The apparatus of claim 24, further comprising:
means for determining that the plurality of weights is expected to result in a crest factor that satisfies a threshold; and
at least one of:
means for adjusting a subset of the plurality of weights based at least in part on determining that the plurality of weights is expected to result in the crest factor that satisfies the threshold, or
means for increasing a quantity of the plurality of weights based at least in part on determining that the plurality of weights is expected to result in the crest factor that satisfies the threshold.
